(19) United States
(12) Patent Application Publication
(10) Pub. No.: US 2005/0125251 A1
(43) Pub. Date: Jun. 9, 2005

(54) System and method for enterprise resource management

(76) Inventors: Kenneth A. Berger, Garland, TX (US); Larry J. Turner, Carrollton, TX (US); Andrew E. Wilcox, Dallas, TX (US)

Correspondence Address: Mr. Christopher John Rourk;GODWIN GRUBER, LLP, 1201 Elm Street, Renaissance Tower, DALLAS, TX, 75270, US

(21) Appl. No.: 11/040,131

(22) Filed: Jan. 21, 2005

Related U.S. Application Data
(63) Continuation of application No. 09/689,067, filed on Oct. 12, 2000, now abandoned.

(51) Int. Cl. G06F 17/60

(52) U.S. Cl. 705/1; 705/8

(57) ABSTRACT

A system for enterprise resource management is provided. The system includes a purchase order helper system that receives purchase order entry data and generates purchase order data. The system also includes a sales order helper system that receives sales order entry data and generating sales order data. An inventory control helper system connected to the purchase order system and the sales order system generates inventory control data based upon the sales order data and the purchase order data. A general ledger helper system coupled to the purchase order helper system, the sales order helper system, and the inventory control helper system generates general ledger data based upon the sales order data, purchase order data, and the inventory control data.

### FIELD OF THE INVENTION

The present invention pertains to the field of enterprise resource management. More specifically, the invention relates to a system and method for enterprise resource management that utilizes classes of helpers in conjunction with a communications protocol that performs enterprise resource management for large, geographically diverse enterprises.

### BACKGROUND

Enterprise resource management (ERM) is a crucial aspect of the business operations of large business enterprises. Purchasing and distributing materials can consume a large percentage of the manpower and budget of the business enterprise. Poor ERM can result in excessive expenditures and overhead, whereas efficient ERM can add significantly to the bottom line of the business enterprise.

Although ERM systems are presently used, such systems experience problems when used with large business enterprises, particularly those with international operations. Such large business enterprises have distributed business operations, and coordination of database updates for ERM functions can be difficult to perform. These difficulties can prevent effective resource management for the purchase of materials, sale of materials, and the transfer of materials within the organization. For example, a large business enterprise may be able to purchase certain materials such as office supplies in bulk for resale at a low price in a first location, but may then purchase those same materials again for use within the enterprise from other vendors in smaller quantities and at higher prices at one or more other locations. Existing ERM systems do not facilitate the coordination of such purchases, particularly for large business enterprises having distributed databases and data processing facilities.

Many large business enterprises have international operations. Systems that provide ERM functions for such enterprises are unable to provide a stable and unified operating environment for the entire enterprise, because of problems with conversion of languages, currencies, coordinating shipments and other logistic and administrative functions, and distributed databases and data processing facilities that may be associated with purchase order entry and update, sales order entry and update, inventory control, and with providing general ledger functions. These problems require ERM systems to be distributed, typically with daily or weekly updates, and prevent international business enterprises from taking full advantage of their international structure to realize cost savings.

Many large business enterprises also have functionally separate divisions that nevertheless use the same information on a realtime basis. For example, accounting, sales, and inventory control organizations may use the same data records for transactions, but data transfers between these organizations are typically limited to daily or weekly updates because of limitations with known enterprise resource management systems.

Therefore, while ERM systems provide some benefits to business organizations, they still suffer from various drawbacks that prevent them from being used to maximize the potential cost savings that can be realized from ERM.

### SUMMARY OF THE INVENTION

In accordance with the present invention, a system and method for enterprise resource management are provided that overcome known problems with systems and methods for enterprise resource management.

In particular, a system and method for enterprise resource management are provided that allow multiple users to access a distributed enterprise resource management system, including users in international locations and in functionally separate parts of the enterprise.

In accordance with an exemplary embodiment of the present invention, a system for enterprise resource management is provided. The system includes a purchase order helper system that receives purchase order entry data and generates purchase order data. The system also includes a sales order helper system that receives sales order entry data and generates sales order data. An inventory control helper system connected to the purchase order system and the sales order system generates inventory control data based upon the sales order data and the purchase order data. A general ledger helper system coupled to the purchase order helper system, the sales order helper system, and the inventory control helper system generates general ledger data based upon the sales order data, purchase order data, and the inventory control data.

The present invention provides many important technical advantages. One important technical advantage of the present invention is a system and method for enterprise resource management that provides helpers that can operate in a multi-threaded environment so as to facilitate enterprise resource management in large business organizations. The helpers of the present invention allow enterprise resource management database coordination in geographically diverse organizations to be effectively managed, even where such organizations include international operations having foreign language translation requirements, currency conversion requirements, shipping cost consideration requirements, discount group requirements, and price group requirements.

Those skilled in the art will further appreciate the advantages and superior features of the invention together with other important aspects thereof on reading the detailed description that follows in conjunction with the drawings.

### BRIEF DESCRIPTION OF THE DRAWINGS

FIG. 1 is a diagram of a system for providing client-server communications in accordance with an exemplary embodiment of the present invention;

FIG. 2 is a diagram of a system for providing client access in accordance with an exemplary embodiment of the present invention;

FIG. 3 is a diagram of a system for providing access to clients from a server in accordance with an exemplary embodiment of the present invention;

FIG. 4 is a diagram of a method 400 providing client-server communications in accordance with an exemplary embodiment of the present invention;

FIG. 5 is a flowchart of a method for providing client-server communications from a client in accordance with an exemplary embodiment of the present invention;

FIG. 6 is a diagram of a system for performing ERM in accordance with an exemplary embodiment of the present invention;

FIG. 7 is a diagram of a system for providing general ledger helper functionality in accordance with an exemplary embodiment of the present invention;

FIG. 8 is a diagram of a system for providing global helper functionality in accordance with an exemplary embodiment of the present invention;

FIG. 9 is a diagram of a system for providing inventory control helper functionality in accordance with an exemplary embodiment for the present invention;

FIG. 10 is a diagram of an order common helper system in accordance with an exemplary embodiment of the present invention;

FIG. 11 is a diagram of a system for performing purchase order functionality in accordance with an exemplary embodiment of the present invention;

FIG. 12 is a diagram of a system for performing sales order functionality in accordance with an exemplary embodiment of the present invention; and

FIG. 13 is a flowchart of a method for performing ERM using one or more helpers in accordance with an exemplary embodiment of the present invention.

### DETAILED DESCRIPTION OF PREFERRED EMBODIMENTS

In the description that follows, like parts are marked throughout the specification and drawings with the same reference numerals, respectively. The drawing figures might not be to scale, and certain components can be shown in generalized or schematic form and identified by commercial designations in the interest of clarity and conciseness.

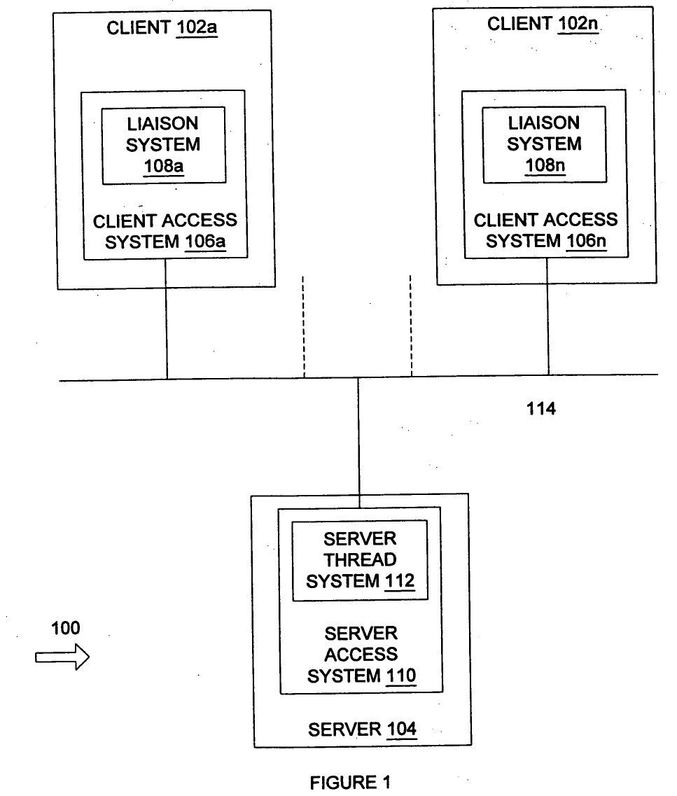

FIG. 1 is a diagram of a system 100 for providing client-server communications in accordance with an exemplary embodiment of the present invention. System 100 allows information about the state of the client to be obtained and maintained by the server, thus facilitating communications between the client and the server.

System 100 includes clients 102a through 102n, which are coupled to server 104 through communications medium 114. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. In one exemplary embodiment, systems and components are coupled to other systems and components through intervening systems and components, such as through an operating system of a general purpose computing platform.

Client systems 102a through 102n can be implemented in hardware, software, or a suitable combination of hardware and software, and can be one or more software systems operating on a Java virtual machine. As used herein, a software system can include one or more objects, agents, threads, lines of code, subroutines, separate software applications, two or more lines of code in two or more corresponding software applications, databases, or other suitable software architectures. In one exemplary embodiment, a software system can include one or more lines of code in a general purpose software application, such as an operating system, and one or more lines of software in a specific purpose software application.

Clients 102a through 102n include client access systems 106a through 106n and liaison systems 108a through 108n, respectively. Client access systems 106a through 106n each provide for communications between server 104 and clients 102a through 102n, respectively. In particular, client access systems 106a through 106n interface with liaison systems 108a through 108n such that the clients 102a through 102n, respectively, only need to interface directly with liaison systems 108a through 108n, and do not have to interface with server 104. Liaison systems 108a through 108n interact with client access systems 106a through 106n, respectively, in order to provide communication services between clients 102a through 102n, respectively, and server 104.

Client access systems 106a through 106n can initiate and maintain communications state data for data requests transmitted from client 102a through 102n, respectively, to server 104. When clients 102a through 102n first initiate contact with server 104, server 104 can first determine whether updates are required for client access systems 106a through 106n, respectively. If such updates are required, then they are first downloaded and installed, such as through the use of Java Archive or “JAR” files. The liaison systems 108a through 108n are then used to interface with the operating system, web browser, or other suitable software systems operating on clients ˜102a through 102n, respectively, such that these systems do not need to interface directly with the server 104. In this manner, any updates or modifications to the software systems operating on clients 102a through 102n can be accommodated by modifications to the liaison systems 108a through 108n, and do not need to be accommodated by modifications to server 104.

Server 104 can be implemented in hardware, software, or a suitable combination of hardware and software, and can be one or more software systems operating on a general purpose server platform. Server 104 includes server access system 110 and server thread system 112. Access between clients 102a and 102n and server 104 is provided for server 104 by server access system 110. Server thread system 112 is used to maintain state information for each of clients 102a through 102n. When a client logs on to server 104, a thread process, such as a Java thread process, is initiated for that client, such that the state of communications with each client can be determined. Thus, if a process operating on server 104 requires notification to a client 102a through 102n, then server 104 can determine whether that client is operational and can use the server thread for that client to initiate data communications with the client.

Server 104 can provide suitable software and hardware services for clients 102a through 102n. Server access system 110 provides a communications interface to server 104 and clients 102a through 102n, such that any updates to software systems operating on server 104 can be accommodated by modifications to server access system 110, without regard to communications systems operating on clients 102a through 102n.

Communications medium 114 can be the Internet, a wireless communications medium, a public switched telephone network, a local area network, a wide area network, other suitable communications media, or suitable combinations of such communications media. Communications medium 114 allows data to flow between clients 102a through 102n and server 104. The data can be transmitted in the form of packets, such that a large number of clients 102a through 102n can access communications medium 114 to transmit and receive data packets.

In operation, system 100 allows state information about clients 102a through 102n to be maintained by server 104. In this manner, server 104 can access data stored on clients 102a through 102n, determine what data has previously been transmitted to client 102a through 102n, and perform other suitable data functions. System 100 thus provides state information for clients and servers in a manner that allows data communications between the server and the clients to be more efficient and effective.

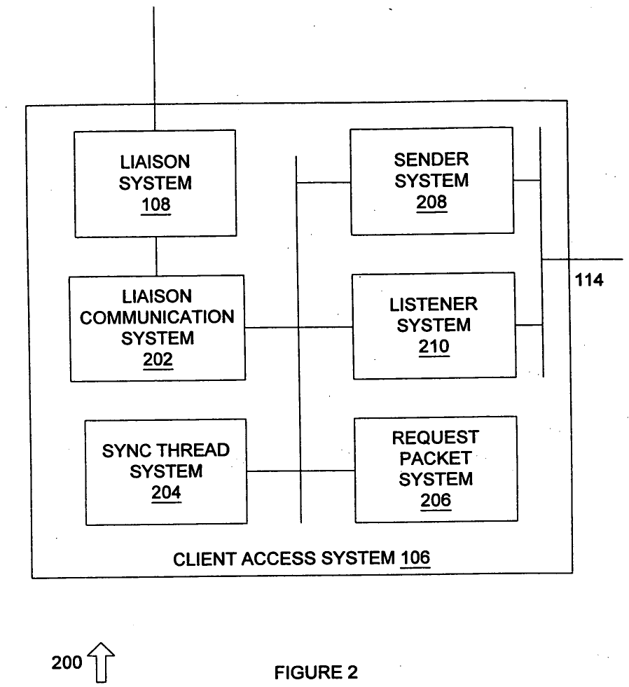

FIG. 2 is a diagram of a system 200 for providing client access in accordance with an exemplary embodiment of the present invention. System 200 includes client access system 106, liaison system 108, liaison communications system 202, synchronization thread system 204, request packet system 206, sender system 208, and listener system 210, each of which can be implemented in hardware, software, or a suitable combination of hardware and software, and which can be one or more software systems operating on a Java virtual machine.

Liaison communications system 202 receives information requests from liaison system 108 and interfaces with synchronization thread system 204 to initiate a synchronization thread process, such as a Java thread process, to manage the information request so as to ensure that the information request is properly sent out, processed, and that a response to the information request is properly handled. Liaison communications system 202 also interfaces with request packet system 206 to compile the information request into a request packet, such as one or more data packets having predetermined header data formats, control data formats, payload data formats, and other suitable data structures.

Liaison communications system 202 then interfaces with sender system 208 to send the request packet to the server, and receives a response packet from the server at listener system 210. Liaison communications system 202 then interfaces with synchronization thread system 204 after the response packet has been received to close down the synchronization thread process, and provides the information in the response packet to liaison system 108 for use by the client 102. The response packet can also include control data or other suitable data that indicates that the response is not completed and that additional response packets are being transmitted. In this situation, the synchronization thread process will not be terminated until all response packets have been received. The response packets can also initiate the transmission of one or more additional request packets, and such request packets can transfer additional data that may be required in order for the server to provide all response data for the initial request data. The response packets can further include response packets generated when the server processes request packets for other clients, where the client is configured to receive and process such non-initiated response packets.

Synchronization thread system 204 can initiate a synchronization thread process upon receipt of a request packet initiation message from liaison communications system 202, and maintains the synchronizationthread process running for that request packet until all response packets are received. Synchronization thread system 204 can maintain multiple synchronization threads for multiple request packets. Request packet system 206 receives the information from liaison system 108 that was subsequently provided to liaison communications system 202 and forms a request packet in response to the information that can include part or all of the information, plus header data, control data, and other suitable data.

Sender system 208 maintains data regarding the identity and address of the server, and can transmit request packets to the server. In one exemplary embodiment, sender system 208 maintains an Internet address for the server, and uses TCP/IP or other suitable Internet protocols to transmit request data packets to the server. Likewise, listener system 210 receives response packets from the server using TCP/IP protocols or other suitable data transmission protocols.

In operation, system 200 allows a client to request information from a server and further provides a uniform liaison interface for the client, such that systems operating on the client do not need to be configured to interface with the server. A synchronization thread system 204 is used to keep track of requests for information sent to the server, and a request packet system 206 is used to format the request in a manner that the server will receive. System 200 can be implemented in Java or other suitable programming languages and can be downloaded as a Java Archive file if the latest version of one or more components of system 200 is not present. In this manner, the software systems operating on the client do not have to be modified when a modification is made to system 200.

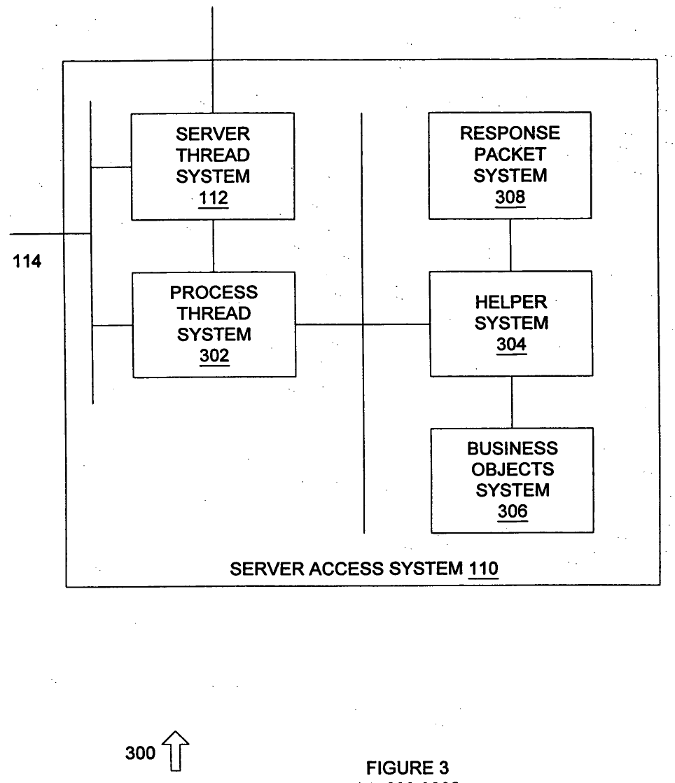

FIG. 3 is a diagram of a system 300 for providing access to clients from a server in accordance with an exemplary embodiment of the present invention. System 300 includes server thread system 112, process thread system 302, helper system 304, business objects system 306 and response packet system 308, each of which can be implemented in hardware, software, or a suitable combination of hardware and software, and which can be one or more software systems operating on a Java server.

Process thread system 302 is coupled to server thread system 112 and communications medium 114, and is used to initiate a process thread process in response to a request packet received from a client by server thread system 112. Process thread system 302 interfaces with helper system 304 after a request packet is received and provides helper system 304 with helper initiation data, such that a different process thread process can be used to manage each helper that is initiated through helper system 304. Likewise, a process thread process can initiate two or more helpers, where suitable, and can manage the two helpers as required to generate the response packet to the request packet. Process thread system 302 also receives a response packet from helper system 304 and can transmit the response packet to the client over communications medium 114.

Process thread system 302 can initiate a new process thread process for a new request packet in a scalable manner, such that a plurality of process thread processes can be supported. In this manner, process thread system 302 allows process thread processes to run in parallel so as to maximize the use of server computing resources.

Helper system 304 includes one or more helpers that can perform predetermined data processing functions. In one exemplary embodiment, helper system 304 can be used to implement an enterprise resource planning system, such that individual helper subsystems of helper system 304 provide general ledger functionality, inventory control functionality, order and sales and purchase order functionality, and other suitable functionality. Likewise, other systems can be implemented by helper system 304, such as online shopping systems, online reservation systems, and other suitable system functionality.

Helper system 304 receives data requests from process thread system 302 and interfaces with business objects system 306 to obtain information responsive to the request. Helper system 304 then assembles one or more response packets that include the information and other suitable data, such as header data and control data, by interfacing with response packet system 308. The information obtained by helper system 304 can also include other information, such as information related to the information request generated by the client, or information for other clients that have not submitted an information request. This information is then provided to response packet system 308 for formation of a suitable response packet.

Business objects system 306 includes a plurality of business objects that are used to obtain data in the server environment. In one exemplary embodiment, business objects system 306 includes objects that are used to interface with databases so as to obtain information from a variety of databases on one or more server platforms, objects that are used to translate between data formats, objects that are used to communicate between systems and components, objects that are used to report data to systems and components, and other suitable objects.

Response packet system 308 receives response data from helper system 304 and business objects system 306, and forms response packets from the data. The response packets can include header data, control data, payload data, and other suitable data. In one exemplary embodiment, the response packets can include data that identifies that a series of response packets are being generated, such that the client system will not terminate the synchronization thread process that is being used to track the corresponding data request. These response packets are then provided to process thread system 302, which provides the information to the client.

In operation, system 300 allows information received from a client at a server to be processed in parallel as one or more process threads. Each client and the process thread processes that are initiated for each client are managed using the server thread system 112. Each process thread process uses helper system 304 to perform functions that are required to respond to the request for information. The response data is formed into a response packet by response packet system 308, which is then provided to process thread system 302 for transmission to the client. Likewise, process thread system 302 can transmit data to other clients where the information returned from helper system 304 so requires.

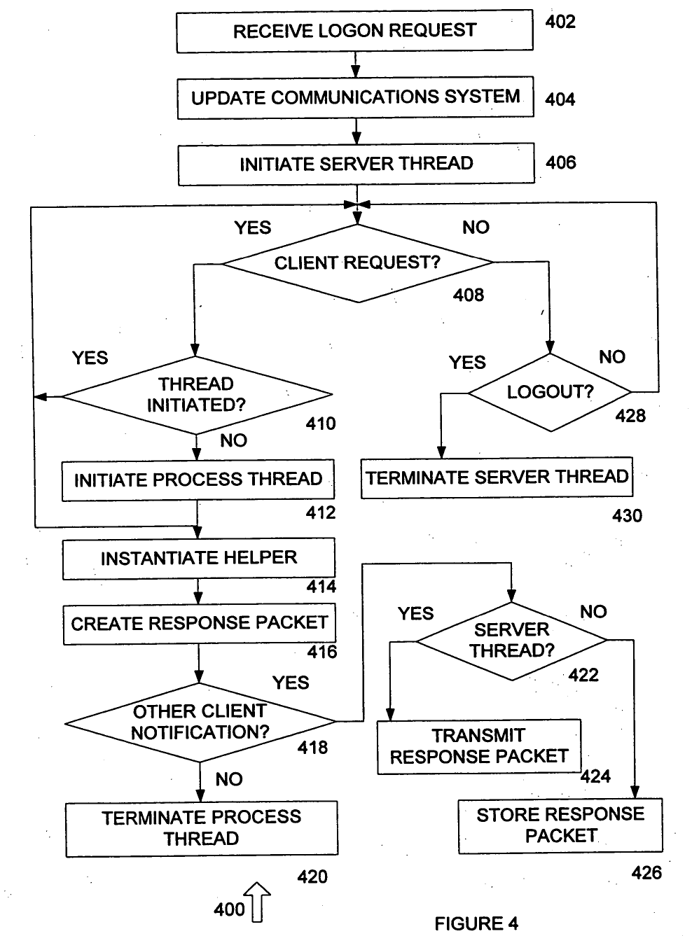

FIG. 4 is a diagram of a method 400 for providing client-server communications in accordance with an exemplary embodiment of the present invention. Method 400 can be implemented by a server to support communications received from a client and to manage data being communicated to a client, or by other suitable systems and components.

Method 400 begins at 402 where a logon request is received from a client. The logon request is processed to determine whether the client has an account with the server. If no client account is identified, then a client registration process can be implemented, a notice can be transmitted, or other suitable processes can be implemented. The method then proceeds to 404 where the client's communication system is updated. In one exemplary embodiment, the version of communications system software files stored on the client is determined, and an updated version of the software files is then transmitted if the version stored on the client is not the latest version.

The method then proceeds to 406 where a server thread process for the client is initiated. The server thread process is maintained while the client is in communication with the server, and is terminated when the client logs off the server, leaves or otherwise becomes unavailable. The server thread process tracks the process thread processes that have been initiated by the user so that a user state can be determined. In addition, the server thread processes can be used to determine whether a given user is logged on to the system, such that the user can be notified of predetermined events, can be provided with response packets for events that the user did not initiate, or for other suitable purposes.

The method then proceeds to 408 where it is determined whether a client request has been received. If a client request has been received, the method proceeds to 410 where it is determined whether a process thread process has been initiated previously in response to the client request. If a process thread process has been initiated, such as in response to an identical client request that was previously received, the method returns to 408. Otherwise, the method proceeds to 412 where a process thread process is initiated. The process thread process then proceeds in parallel as the method returns to 408 where another client request is awaited.

For the process thread process initiated at 410, the method proceeds to 414 where the process thread process manages one or more helpers that are initialized and executed to assemble data responsive to the request. The helper can be one of a plurality of helpers that are used for specialized purposes, such as for general ledger functions, purchase order functions, inventory control functions, sales order functions, catalog functions, auction functions, reservation functions, or other suitable functions. The method then proceeds to 416 where a response packet is created based upon data received by the helper. The response packet can also include data for clients other than the one that initiated the request. In one exemplary embodiment, a credit manager client can receive a response packet when a user exceeds a credit limit. Other suitable data can likewise be provided to clients that have not explicitly requested the data.

The method proceeds to 418 where it is determined whether another client should receive the response packet. If it is determined that no other client requires the response packet, the process thread process is terminated and the response packet is transmitted to the client. Otherwise, the method proceeds to 422 where it is determined whether a server thread process is running for that other client. If a server thread process is running, the method proceeds to 424 where the response packet is sent. Otherwise, the method proceeds to 426 where the response packet is stored for subsequent transmission, such as after the client logs on.

If it is determined at 408 that a client request has not been received, the method proceeds to 428 where it is determined whether a logout or logoff command has been received. The logout command can be a command entered by the client, can be a timeout command, or can be other suitable commands. If it is determined that a logout command has not been received, the method returns to 408. Otherwise, the method proceeds to 428 where the server thread process is terminated.

In operation, method 400 allows a server to communicate with a plurality of clients in a manner that allows the state of the client-server communications to be determined. Method 400 further provides a scalable environment for providing server resources whereby a plurality of server thread processes are used to manage a corresponding plurality of clients, and where a plurality of process thread processes are used to manage a corresponding plurality of helper functions that are used to process request packets that are received from the clients. The helper functions receive request data from the clients and generate response data for that client and other clients, where suitable.

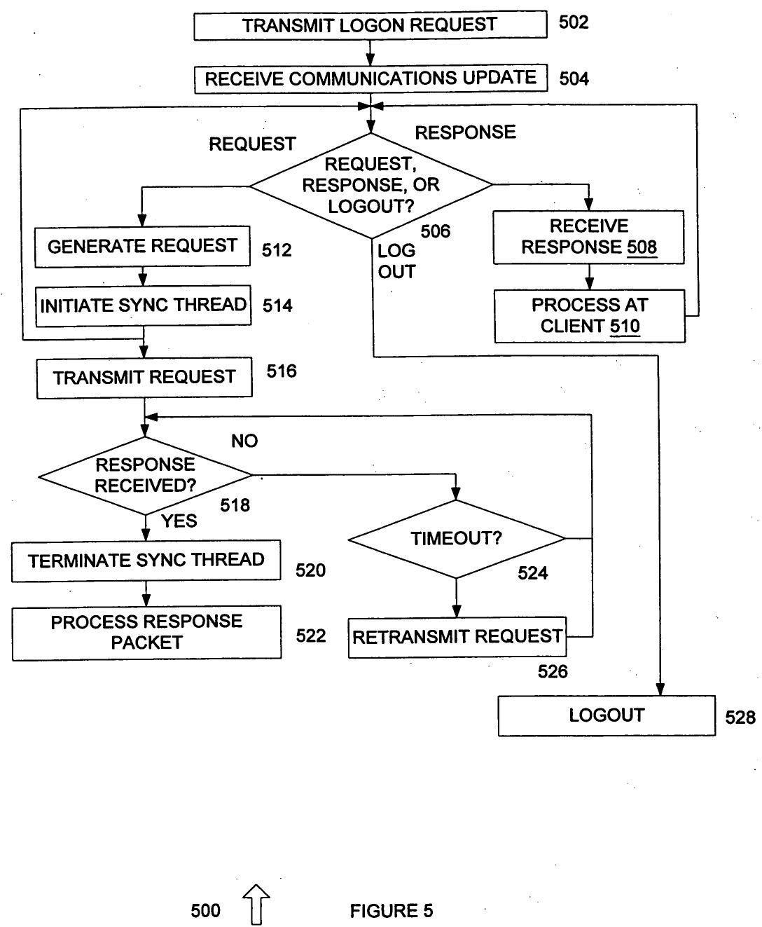

FIG. 5 is a flowchart of a method 500 for providing client-server communications from a client in accordance with an exemplary embodiment of the present invention. Method 500 begins at 502 where a logon request is transmitted. The method then proceeds to 504 where a communications systems update is received. In one exemplary embodiment, the communications system update can be performed by receiving a request for version data of communications system executable files being used. If more recent versions of the communications system files are available, they are then provided to the client. Other suitable procedures can be used. The method then proceeds to 506.

At 506, it is determined whether a request has been received from the client, whether one or more response packets have been received from the server, or a logout command has been received from the client. If one or more response packets have been received, such as from the server in response to functions performed for other clients, then the method proceeds to 508 where the response data is received at the client. For example, each response packet can include header data, control data, and other suitable data that can be extracted and processed to determine the system operating on the client that should be provided with the data. Each response packet can be processed in other suitable manners, where the processing functionality can be received with the communications system files at 504. The method then proceeds to 510 where the response data is processed by the client.

If it is determined at 506 that a request has been received from the client, the method proceeds to 512 where one or more request packets are generated. For example, the client can include a liaison system that interfaces with client software functionality, and an additional system or systems that provide functionality for transforming requests received from the client software functionality into one or more request packets, each having a standardized request format. The method then proceeds to 514 where a synchronization thread process is initiated. The synchronization thread process is used to keep track of the status of the information request, and also to allow multiple information requests to be processed in parallel by the client in a manner that prevents response packets from being received in response to the incorrect request or at an incorrect client. The method then proceeds to 516, and returns to 506 where another request can be received and another synchronization thread can be initiated.

For the synchronization thread initiated at 514, each request packet is transmitted to the server at 516, such as through a sender system or other suitable systems. The method then proceeds to 518, where it is determined whether a response has been received from the server. If no response has been received, the method proceeds to 524 where it is determined whether a timeout has occurred. If a timeout has occurred, the method returns to 518. Otherwise, the method proceeds to 526 where each request packet is retransmitted to the server. The method then returns to 518.

If it is determined at 518 that a response has been received, the synchronization thread process is terminated, and the method proceeds to 520 where the response packet data is processed by the client, such as by extracting header and control data from each response packet and performing other suitable processing.

If it is determined at 506 that a logout command has been received, the method proceeds to 528 where logout is performed. Logout can include notifying the server of logout so that the server thread process for the client can be terminated, shutting down the client without notification to the server, or other suitable processes.

In operation, method 500 allows data to be requested and processed at a client, and further allows the client to maintain information regarding the status of the request through the use of multiple synchronization thread processes. Method 500 allows a client state to be maintained at a server, and further allows a client to receive data from a server in response to events occurring at other systems.

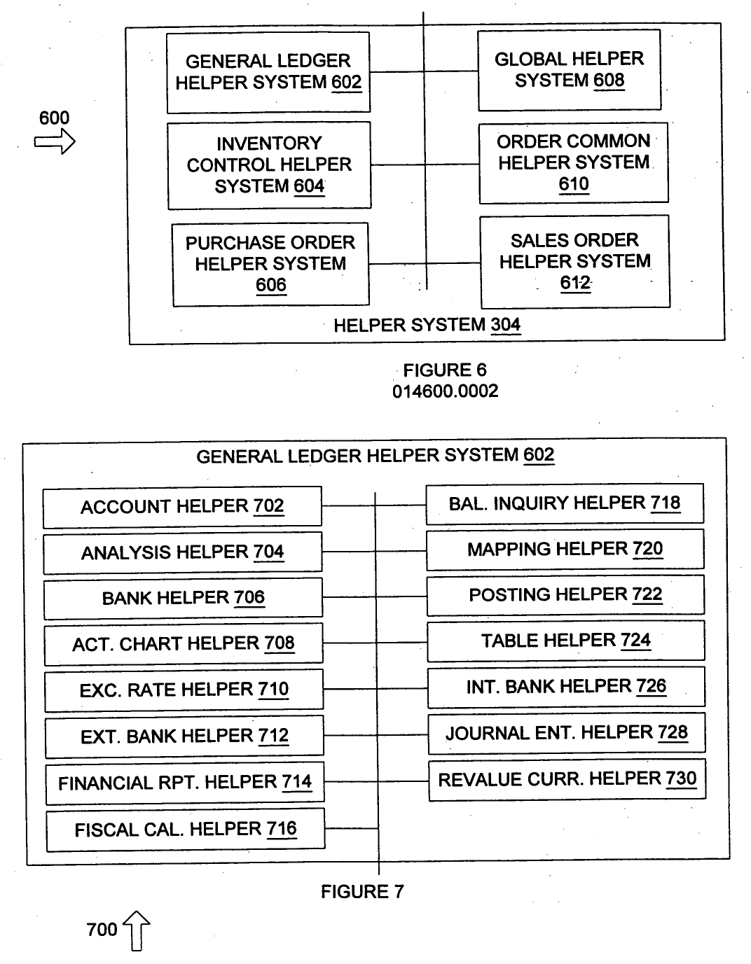

FIG. 6 is a diagram of a system 600 for performing ERM in accordance with an exemplary embodiment of the present invention. System 600 includes helper system 304, general ledger helper system 602, inventory control helper system 604, purchase order helper system 606, global helper system 608, order common helper system 610, and sales order helper system 612, which can each be implemented in hardware, software, or a suitable combination of hardware and software, and which can be one or more software systems operating on a general purpose server platform. These helpers can be used in conjunction with a suitable server access system, such as server access system 110, to provide ERM services.

General ledger helper system 602 includes one or more helpers that are used to perform general ledger functions in an ERM system. In one exemplary embodiment, general ledger system 602 includes helpers that are used to perform functions such as providing account data for predetermined accounts, providing analysis of the general ledger data, providing chart of account data, allowing journal entries to be made and revised, allowing interfacing to occur with internal banks (such as banks used by the enterprise) or external banks (such as banks used by businesses that the enterprise interacts with), and other suitable general ledger functions. In this manner, general ledger helper system 602 allows general ledger data to be entered and retrieved in response to suitable end user commands so as to perform ERM.

In one exemplary embodiment, general ledger helper system 602 is used in conjunction with a system for providing client-server communications, such as system 100 shown in FIG. 1. Screen data prompts, such as screen images generated with *.HTML or *.XML data in conjunction with a web browser, provide the user with multiple options, such as a prompt for account data, a prompt to enter a journal entry, a balance inquiry prompt, and other suitable prompts. The user then selects a prompt, such as by entering predetermined information, e.g. an account number, a name, journal entry data, or other suitable data. The system then transmits this data to helper system 304 by a suitable procedure. General ledger helper system 602 then receives the user-entered data and performs the general ledger helper functions to provide the functionality required by the user. After the suitable general ledger functionality has been performed, such as storage of a journal entry, retrieval of chart of accounts data, or other suitable functions, the data generated in response is then transmitted back to the user, where it is displayed by suitable screen displays. In this manner, general ledger helper system 602 performs general ledger functionality for one or more users in a manner that allows multithreading of general ledger helper system 602 functionality.

Inventory control helper system 604 includes one or more helpers that provide inventory control functionality in an ERM system. In one exemplary embodiment, inventory control helper system 604 provides helpers that allow inventory to be located in warehouses, that allow warehouse stocking reports to be generated so that warehouse workers can retrieve the inventory from the warehouse, pick confirmation helpers that allow the selection and shipment of items from the warehouse inventory to be tracked, and other suitable inventory control functionality to be provided. Inventory control helper system 604 interfaces with other suitable helper systems, such as sales order helper system 612, to allow sale fulfillment to be integrated with sale order entry.

Purchase order helper system 606 includes one or more helpers that provide purchase order functionality in an enterprise resource management system. In one exemplary embodiment, purchase order helper system 606 provides functionality for entering purchase orders, such as orders requesting the purchase of one or more inventory items. Purchase order helper system 606 can interface with internal order partners, external order partners, or other suitable parties. Purchase order helper system 606 is also functional to provide discount category data, discount group data, price group data, or other suitable data functionality, such as to allow the purchase order to be generated with prices for appropriate discount categories and order partners. In one exemplary embodiment, purchase order helper system 606 can generate purchase orders for internal partners with price discounts that reflect savings from markups charged to external entities, as well as purchase orders for external entities that do not reflect such discounts.

Global helper system 608 includes one or more helpers that provide functionality for the ERM system that can be used in conjunction with other functions, such as general ledger functions, inventory control functions, purchase order functions, and sales order functions. In one exemplary embodiment, global helper system 608 includes product class code data functionality, shipping data functionality, language functionality, currency conversion functionality, and other helper functionality that is required for the performance of ERM.

Order common helper system 610 includes one or more helpers that provide functionality for purchase order and sales order processing. In one exemplary embodiment, order common helper system 610 provides functionality for logging orders, determining product price, determining tax jurisdiction, and other functionality that performs the entry of orders in an ERM system.

Sales order helper system 612 includes one or more helpers that are used to provide sales order processing functionality in an ERM system, such as for entry of a sales order from the selling organization to an internal or an external customer. In one exemplary embodiment, sales order helper system 612 includes discount category data functionality, order partner data functionality, discount group data functionality, and sales order tracking functionality that performs the entry of sales orders. Sales order helper system 612 allows a sales order for an ERM system to be entered, such that the items that have been sold are then logged to an inventory control helper system and general ledger helper system to allow the items to be retrieved from inventory and shipped, and to allow billing functions to be coordinated so that billing and payment data can be matched with sales data.

In operation, system 600 allows ERM to be performed in conjunction with a suitable distributed enterprise communication system such as system 100 of FIG. 1. The helper systems of system 600 provide ERM functionality that allow sales or purchase orders to be entered, inventory control for the corresponding sales to be tracked, and general ledger data for the orders to be processed, such that unified information and reporting capability can be provided for purchased or sold items. In this manner, system 600 allows ERM functionality to be multi-threaded such that two or more users can perform ERM tasks in parallel, which can be especially advantageous for large international business enterprises.

FIG. 7 is a diagram of a system 700 for providing general ledger helper functionality in an ERM system in accordance with an exemplary embodiment of the present invention. System 700 includes general ledger helper system 602 and additional helpers as described herein, and allows general ledger data to be assembled from one or more servers, including servers that are located in geographically diverse areas. The helpers provide multi-threaded capability such that multiple helper requests can be processed in parallel.

Account helper 702 receives account query data, entry data, update data, or other suitable data in an ERM system, and returns account data or performs account data entry or updating. The account data queries can include predetermined account identification information, such as the name of the account holder, the location of the account holder, an account number, or other suitable account identifying information. Account helper 702 identifies accounts matching the account identification data and returns account data in response to the account data request.

Analysis helper 704 performs general ledger analysis in response to analysis request data. Analysis helper 704 can receive suitable analysis request data, such as profit and loss, total sales, company data, warehouse data, account data, or other suitable analysis selection data, and can perform the requested analysis using data stored for the corresponding entity. In one exemplary embodiment, analysis helper 704 can perform a profit and loss analysis by item according to a company, a warehouse location, and account numbers serviced by the warehouse. Thus, analysis helper 704 can perform general ledger analysis to identify relevant financial information pertaining to ERM.

Bank helper 706 provides internal and external bank interface functionality. Bank helper 706 can receive bank prompt data, such as a prompt to obtain account balances, to make a payment, to receive payments, to update user-modifiable data fields, or other suitable bank prompt data, and can then interface with internal or external bank systems to perform the requested functionality. Bank helper 706 then returns response data, such as data indicating that a payment has been made, data indicating that a payment has been received, account balance data, or other suitable bank data. Bank helper 706 stores suitable account data to allow the user to interface with one or more bank systems, such that individual bank account number and location data does not need to be known to the user in order to access the bank data for a specific customer or other suitable entities.

Chart of accounts helper 708 receives chart of accounts query data, entry data, edit data, or other suitable data in an ERM system, and returns chart of accounts data from the general ledger system or performs chart of accounts data entry or updates. In one exemplary embodiment, chart of account data includes predetermined accounts that have been set up for the general ledger system with additional information that provides balances, profits, losses, or other suitable information. Chart of accounts helper 708 can receive one or more category data types from the user, such that the data returned by chart of accounts helper 708 corresponds only to those categories requested by the user.

Exchange rate helper 710 provides exchange rate functionality for general ledger purposes. In one exemplary embodiment, exchange rate helper 710 is used to convert between general ledger entries that can be entered in different currencies, such as for multinational corporations or enterprises that have local operations where costs are entered according to the local currency. Exchange rate helper 710 thus allows reports to be generated and financial data to be determined and translated into a user-selectable currency, even where the data is entered in another location and another currency.

External bank helper 712 performs external bank interface functions in response to a request for external bank interface functionality. In one exemplary embodiment, external bank helper 712 can receive requests for account balances, for payment, to receive payment, or other suitable functionality and interfaces with the external bank system to provide the functionality and return response data, data indicating that the functionality has been provided, that an error has occurred, or other suitable data.

Financial report helper 714 receives financial report query data, entry data, edit data, or other suitable data in an ERM system, and returns financial report data according to the requested data in predetermined formats or performs financial report entry or updates. In one exemplary embodiment, financial report helper 714 receives financial report parameters, such as company, warehouse, period, inventory identifiers, or other suitable data, and returns financial report data in accordance with the parameters.

Fiscal calendar helper 716 receives fiscal calendar query data, entry data, update data, or other suitable data in an ERM system, and performs fiscal calendar analysis, returns fiscal calendar data, or performs fiscal calendar entry or updating. In one exemplary embodiment, fiscal calendar helper 716 can organize sales, shipment, billing, payment, expense, or other suitable data according to fiscal calendars, such as government fiscal calendars, company fiscal calendars, tax fiscal calendars or other suitable fiscal calendars.

Balance inquiry helper 718 receives balance inquiry query data and interfaces with accounts in an ERM system to return the balance inquiry data. Balance inquiry helper 718 can be used to obtain balance data for customer accounts, bank accounts, credit accounts, debit accounts, or other suitable accounts.

Mapping helper 720 provides mapping functionality between databases in an ERM system. An ERM system can include two or more different database systems, such that any database entry, update, or query requires mapping to occur between the user's database and the database on which the information resides. Mapping helper 720 thus tracks the database type, number of fields, field data type, field data size, and other suitable information to allow data to be readily mapped between databases without user interaction.

Posting helper 722 provides general ledger access functionality in an ERM system to allow general ledger entries to be posted in the general ledger. In one exemplary embodiment, posting helper 722 receives general ledger entry data from a user and makes the appropriate general ledger updates based upon the general ledger entry data. Posting helper 722 also provides response data that indicates whether the posting was accepted, whether there were any problems with the posting, or other suitable data.

Table helper 724 receives table request data in an ERM system and converts abstract general ledger posting data into a particular entity's general ledger format. In one exemplary embodiment, table helper 724 receives a request for tabular data from the general ledger and interacts with other suitable helpers such as mapping helper to map the general ledger data to the requesting entity's general ledger inventory numbers. Likewise, table helper 724 can receive company identification data such that the requestor can be from a different entity and still obtain the general ledger data for other companies in the format used by the requestor's entity.

Internal bank helper 726 receives internal bank data query, entry data, update data, or other suitable data for user-modifiable fields in an ERM system and provides internal bank data in response or performs data entry or modification to the internal bank data. Internal bank helper 726 can interface with external bank accounts for affiliated internal organizations, internal bank accounts that are held within the organization, and other suitable internal banks.

Journal entry helper 728 provides journal entry functionality for the general ledger in an ERM system. In one exemplary embodiment, journal entry helper 728 can receive new journal entry data and can enter the data into the general ledger. Likewise, journal entry helper 728 can audit journal entries to ensure that the correct data was entered, enter corrected data, retrieve journal entries based upon user-selected or predetermined criteria, and perform other suitable journal entry functions.

Revalue currency helper 730 provides currency revaluation functionality for general ledger entries in an ERM system. In one exemplary embodiment, a multinational entity or enterprise can include general ledger entries in various currencies. Revalue currency helper 730 allows currency to be revalued based upon current or user entered exchange rates, such as to assist with general ledger functions or to facilitate decision making on when to effect currency transfers.

In operation, system 700 provides general ledger helper functionality for an ERM system in a suitable multi-threaded environment such as system 100. System 700 allows multiple users to access general ledger functionality in a manner that allows access to the general ledger while controlling data entered into the general ledger so as to maintain consistency of data. System 700 also is configured for use in large enterprises, such as international enterprises, where a large number of users can access or require access to the general ledger on a continual basis, and where such users can enter data in accordance with different data and currency conventions.

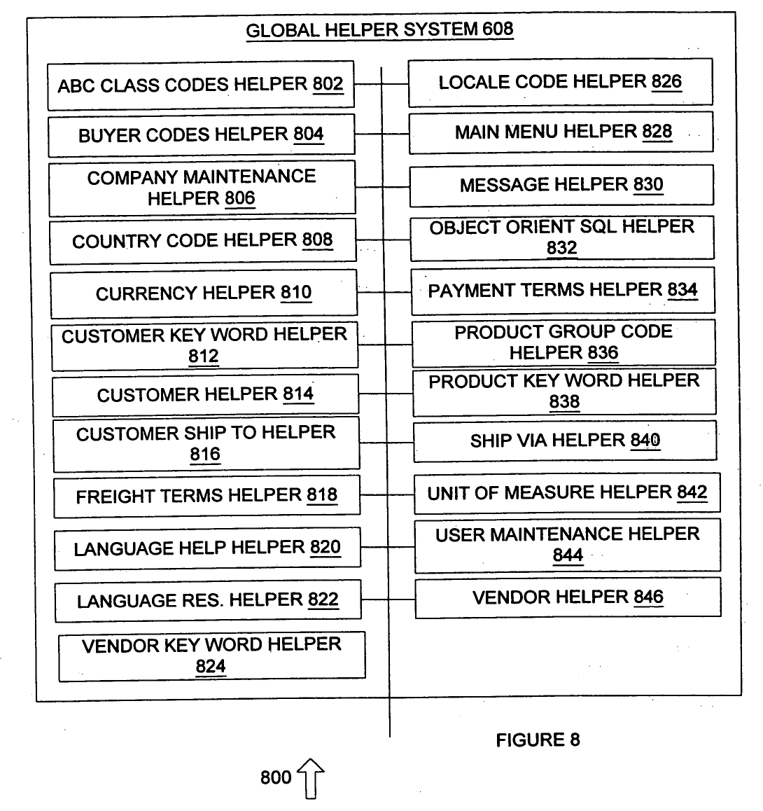

FIG. 8 is a diagram of a system 800 for providing global helper functionality for an ERM system in accordance with an exemplary embodiment of the present invention. System 800 includes global helper system 608 and additional global helper functionality that can be used by one or more helper systems of system 600.

ABC class codes helper 802 receives inventory classification query data, entry data, update data, or other suitable data, and returns inventory classification data or performs the entry or updating of the inventory classification data. In one exemplary embodiment, inventory can be classified according to shelf life or turnover rates. In this exemplary embodiment, “A” inventory has a short shelf life, with succeeding identifiers such as “B,” “C,” etc. representing inventory that has increasingly longer shelf lives and turnaround times. ABC class codes helper 802 can be used to provide restocking estimate data or other suitable data for an ERM system.

Buyer codes helper 804 receives buyer code query data, entry data, update data, or other suitable data in an ERM system, and returns buyer code data or performs buyer code entry or update. Buyer codes helper 804 thus facilitates the submission of sales orders to buyers or purchase orders to sellers by allowing users to readily identify buyers and buyer codes in an ERM system.

Company maintenance helper 806 receives company query data, entry data, update data, or other suitable data in an ERM system and performs the entry and maintenance of company data. Company maintenance helper 806 allows company billing information, billing address, shipping address, contact information, and other suitable company data to be entered and edited.

Country code helper 808 receives country code query data, entry data, update data, or other suitable data in an ERM system and returns country code data or performs entry or updating of the country code data. Country code data can be used for shipping, purchase order, sales order, or other suitable purposes in an ERM system.

Currency helper 810 receives currency query data, entry data, update data, or other suitable data, and provides currency response data or performs the currency update or entry. For example, new currencies can be entered, currency exchange rates can be manually adjusted, automatically adjusted, provided in response to requests, or other suitable currency functionality can be provided for use in an ERM system.

Customer key word helper 812 receives customer key word query data, entry data, update data, or other suitable data in an ERM system and returns customer key word data in response to the customer key word query data or performs entry or editing of customer key words. For example, customer key words can be used to identify organizations, functions, locations, or other suitable key word functionality, and can have associated information such as expanded definitions, affected customers, relevant business sectors, or other associated information.

Customer helper 814 provides customer interface functionality in an ERM system. Customer helper 814 can provide customer location data, shipping data, contact data, or other suitable customer data in response to predetermined or user-defined queries. Customer helper 814 also allows customer data to be entered or edited.

Customer shipped to helper 816 receives customer shipping query data, edit data, entry data, or other suitable data in an ERM system and provides customer shipping data or performs customer shipping data entry or updating. Customer shipping data can include address data, shipping date data, carrier identification data, or other suitable data, in response to predetermined or user defined customer shipping data queries.

Freight terms helper 818 receives freight term query data, edit data, entry data, or other suitable data in an ERM system and provides freight term data or performs the requested freight term entry or update. Freight terms for an ERM system can include payment terms, status terms, packaging terms, or other suitable data, as a function of the item being shipped, the business entity, the location, or other suitable criteria.

Language help helper 820 receives language help query data, entry data, edit data, or other suitable data for an ERM system and provides the requested language help data or performs the requested data entry or update. Language help for an ERM system can include definitions, translations, <or other suitable language data.

Language resource helper 822 receives language resource query data, entry data, update data, or other suitable data for an ERM system, and returns language resource data in response to the queries or performs entry or update of language resource data. Language resource data can include identification data, such as name, telephone number, email address, and other suitable data, for personnel who can speak predetermined languages or other language resources. Language resource helper 822 can also interface with a translation system to translate words, phrases, documents, or other data.

Vendor key word helper 824 receives vendor key word query data, entry data, update data, or other suitable data in an ERM system, and returns corresponding vendor key words or performs the entry or modification of vendor key words. Vendor key words can be used by vendors to identify locations, goods, or other suitable information, and can be required for purchase orders, sales orders, shipping orders, or other suitable uses.

Local code helper 826 receives local code query data, entry data, update data, or other suitable data in an ERM system, and returns local code data for identifying shipping addresses, shipping routes, or other suitable information, or performs the entry or modification of local code data.

Main menu helper 828 receives main menu query data, entry data, update data, or other suitable data in an ERM and returns main menu data in response to the query or performs entry or updating of the main menu data. In one exemplary embodiment, main menu helper 828 receives a user selected main menu entry and returns data responsive to that main menu selection.

Message helper 830 receives message query data, entry data, update data, or other suitable data in an ERM system and locates messages in response to the message query data or performs message entry or editing. In one exemplary embodiment, message helper 830 can provide explanatory material in response to an error message.

Object oriented SQL helper 832 receives user entered or predefined SQL database queries in an ERM system and performs SQL database queries based upon the user defined or predetermined queries. Object oriented SQL helper 832 returns the results of the SQL database query for presentation to the user.

Payment terms helper 834 receives payment query data, entry data, update data, or other suitable data in an ERM system and returns payment terms to the user in response to the payment terms query data or performs the requested entry or update. In one exemplary embodiment, payment terms helper 834 can receive requests for payment terms for certain classes of inventory, for certain companies, for certain locations, or other suitable payment term data. Such payment terms can vary as a function of country, type of good, company, or other categories or classifications.

Product group code helper 836 receives product group code query data, entry data, edit data, or other suitable data and returns product group code data in response to the query data or performs the requested data entry or update. In one exemplary embodiment, a user can request product group code data from an icon associated with a product listing, such that product group code helper 836 receives the user entered selection and product data and returns product group ode data in response to the user selection.

Product key word helper 838 receives product key word query data, entry data, update data, or other suitable data in an ERM system and returns product key word data in response to the query or performs the requested data entry or update. Product key word data can be used by business organizations, sellers, buyers, or other suitable entities. For example, product key words can be used to identify differences in products by country.

Ship via helper 840 receives shipping query data, entry data, update data, or other suitable data in an ERM system and returns the shipping data in response to the query or performs the requested data entry or update. The ship via data can include information regarding types of shipping that can or must be used for particular types of inventory. In one exemplary embodiment, inventory can have variable shipping requirements. For example, inventory with a short shelf life may need to be shipped via air, whereas inventory with long shelf life may be shipped via less expensive land or sea shipping methods, which can take longer times but may be acceptable where they will not result in damage to the product.

Unit of measure helper 842 receives unit of measure query data, entry data, update data, or other suitable data for an ERM system and returns unit of measure data in response to the query data or performs the data entry or update. In one exemplary embodiment, a user can request units of measure for a product category or catalogue listing and can receive the units of measure related with that listing. For example, if a product catalogue states that an item costs $48.00 per unit, a unit of measure query can be received by unit of measure helper 842, which then determines what unit of measure is assigned to that catalogue entry.

User maintenance helper 844 receives user maintenance data in an ERM system, such as entry or update of user data, and performs the requested user entry or update functions. For example, user data for a user may be entered or edited, such as a key word, user name, location, or other suitable user data.

Vendor helper 846 receives vendor query data, edit data, entry data, or other suitable data in an ERM system and returns vendor data in response to the vendor query data or performs the requested data entry or update. Vendor helper 846 can help locate vendors, provide comment data for use in selecting between competing vendors, or perform other suitable vendor-related functions.

In operation, system 800 is used to provide global helper functionality for use in an ERM system. System 800 provides functionality that is used for general ledger functions, inventory control functions, purchase order functions, and sales order functions, and allows such functionality to be multi-threaded so as to facilitate multiple access to the functionality, particularly in large enterprises.

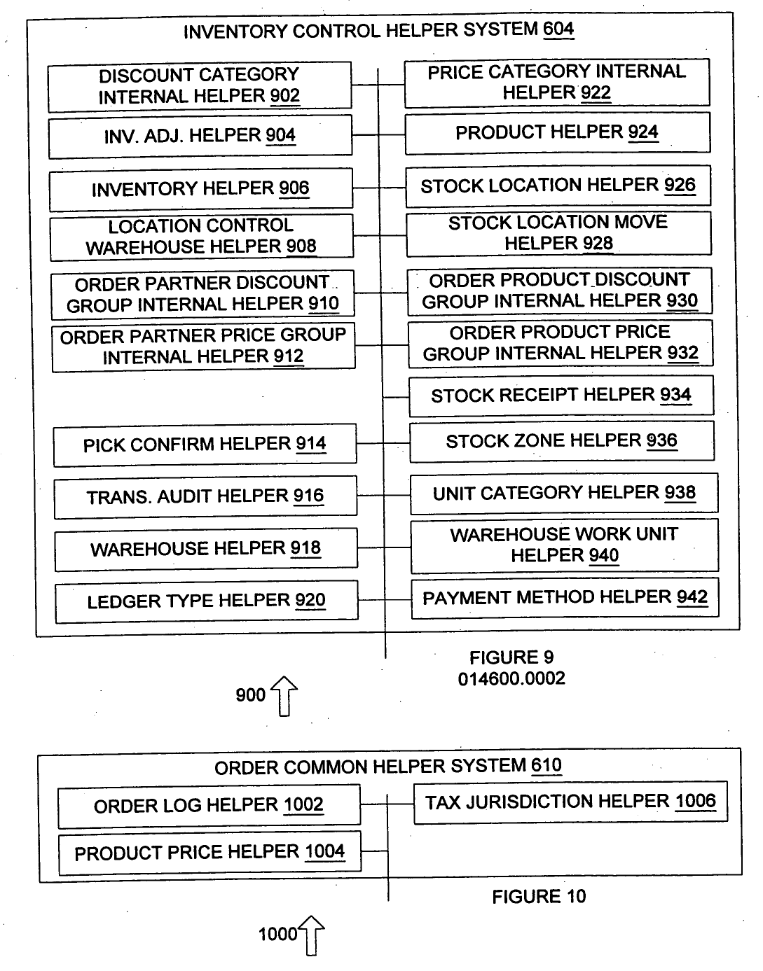

FIG. 9 is a diagram of a system 900 for providing inventory control helper functionality in accordance with an exemplary embodiment for the present invention. System 900 includes inventory control helper system 604 and additional helper functionality as described below for use in an ERM system.

Discount category internal helper 902 receives internal discount category query data, entry data, update data, or other suitable data in an ERM system, and returns discount category data in response to the discount category query data or performs entry or update of the discount category data. Discount category internal data can include discount categories for an internal customer of the enterprise that is purchasing inventory.

Inventory adjustment helper 904 receives predefined or user entered manual inventory adjustment data and performs inventory adjustment functionality in response to the user-entered data. In one exemplary embodiment, inventory adjustment helper 904 is used to adjust inventory levels based upon observation, or other input.

Inventory helper 906 receives inventory query data, entry data, update data, or other suitable data in an ERM system, and returns inventory data in response to the inventory query or performs the entry or editing of the inventory data. For example, inventory helper 906 can receive a request to provide current inventory levels as a function of company, warehouse, or other suitable classifications, and can return the requested inventory data after interfacing with suitable databases at one or more locations.

Location control warehouse helper 908 receives location control warehouse query data, entry data, edit data, or other suitable data in an ERM system, and returns location control warehouse data in response to the query or performs entry or updating of the location control warehouse data. In one exemplary embodiment, the location control warehouse data can include locations within warehouses where inventory can be found, such as to retrieve inventory in response to an order.

Order partner discount group internal helper 910 receives query data, entry data, update data, or other suitable data for order partner discount groups for internal order partners in an ERM system and returns corresponding discount group data for internal order partner discount groups or performs entry or updating of the data.

Order partner price group internal helper 912 receives query data, entry data, update data, or other suitable data for order partner price groups for internal order partners in an ERM system and returns the corresponding price group data in response to the price group query data or performs entry or updating of the data.

Pick confirm helper 914 receives pick confirm query data, entry data, edit data or other suitable data in an ERM system and returns inventory selection reports that are generated to assist with the selection of inventory in response to purchase orders or shop orders, or performs the requested entry or edit functions. Pick confirm helper 914 can confirm changes in inventory levels in response to inventory selection reports, and can also be used to edit prior incorrect entries, audit existing data, or perform other suitable functions.

Transaction audit helper 916 receives transaction audit query data, entry data, edit data, or other suitable data in an ERM system and returns transaction audit data in response to the transaction audit query data or performs the requested data entry or update. In one exemplary embodiment, transaction audit helper 916 allows a transaction to be audited, such as to show the sequence of the transaction from order entry through shipping and payment, so as to facilitate trouble shooting of potential transaction problems.

Warehouse helper 918 receives warehouse query data, entry data, update data, or other suitable data in an ERM system and returns warehouse data in response to the query or performs the entry or edit functions. Warehouse helper 918 can be used to add, edit, or locate warehouses where items are stored, locations within the warehouse where items are stored, locate warehouses having additional space, or other suitable functions.

Ledger type helper 920 is used to identify, add, or edit ledger types for items in the chart of accounts for an ERM system and provides ledger type data in response to query data or performs the requested entry or update. For example, an item can be classified as an asset, a liability, a revenue, an expense, or other suitable classifications can be used in accordance with a general ledger bookkeeping functionality.

Price category internal helper 922 receives price category internal query data, entry data, update data, or other suitable data in an ERM system and returns price category internal data in response to the query or performs the data entry or update. For example, an internal price category can be used to track discounts for internal purchases within the enterprise.

Product helper 924 receives product query data, entry data, update data, or other suitable data in an ERM system and returns product data in response to the product query data or performs the data update or entry. For example, product helper 924 can be used to provide information regarding the product, the uses for the product, where the product was supplied from, or other suitable product data.

Stock location helper 926 receives stock location query data, entry data, update data, or other suitable data in an ERM system and returns stock location data in response to the query data or performs the requested data entry or update. In one exemplary embodiment, stock location helper 926 receives stock location queries such as requests that identify particular inventory numbers, package sizes, or other suitable stock data and then returns data showing where such stock is located.

Stock location move helper 928 receives stock location move query data, entry data, update data, or other suitable data in an ERM system and performs corresponding stock location move functions in response to the data or enters or edits the data. In one exemplary embodiment, stock location move helper 928 receives stock location data and accompanying movement instructions, such as movement data instructing stock to be moved from one location in the warehouse to a different location in the warehouse, from one warehouse to a different warehouse, or other suitable stock location movement data.

Order product discount group internal helper 930 receives order product discount group query data, entry data, update data, or other suitable data for an ERM system for internal organizations, and provides discount group data in response to the discount group query or performs the requested data entry or update. Internal order products are products that are provided to different organizations within an enterprise. Discount group data is used to determine discounts for products that are provided to internal organizations within the enterprise, such as quantity discounts, direct shipping discounts, or other suitable discounts.

Order product price group internal helper 932 receives order product price group query data, entry data, update data, or other suitable data for an ERM system for internal organizations, and provides price group data in response to the price group query or performs the requested data entry or update. Price group data is used to determine prices for products that are provided to internal organizations within the enterprise, such as bulk prices, local versus imported prices, or other suitable prices.

Stock receipt helper 934 receives stock receipt query data, edit data, entry data, or other suitable data in an ERM system and returns suitable stock receipt data in response to the stock receipt query or performs the requested data entry or update. In one exemplary embodiment, stock receipt helper 934 receives a stock receipt request that identifies predetermined stock and generates a stock receipt in response to the request. In another exemplary embodiment, stock receipt helper 934 receives confirmation of placement of inventory in stock in response to a loading report, or other suitable reports.

Stock zone helper 936 receives stock zone query data, entry data, update data, or other suitable data in an ERM system and returns stock zone data in response to the query or performs the requested data entry or update. In one exemplary embodiment, stock zone helper 936 can receive inventory identification data and return information showing the location of the inventory within the warehouse.

Unit category helper 938 receives unit category query data, entry data, update data, or other suitable data in an ERM system and returns unit category data in response to the query data or performs the requested data entry or update. In one exemplary embodiment, unit category helper 938 receives unit category data associated with a product, and returns the units of measure for that unit category.

Warehouse work unit helper 940 receives warehouse work unit query data, entry data, update data, or other suitable data in an ERM system and returns warehouse work unit data in response to the query or performs the requested update or entry. In one exemplary embodiment, warehouse work unit helper 940 can receive a request for estimating warehouse work unit time for stocking items or retrieving a list of inventory items, and can return the amount of time it will take a warehouse worker to stock the items or to assemble an order comprising the inventory items identified.

Payment method helper 942 receives payment method query data, edit data or entry data in an ERM system and returns the payment method data in response to the query or performs the requested data entry. In one exemplary embodiment, payment method helper 942 receives a payment method query for a type of inventory, location, customer, or other suitable data and returns payment method type data associated with that classification.

In operation, system 900 is used to provide inventory helper functionality to assist with inventory control in an ERM system. Inventory control helper system 900 performs data transactions associated with stocking inventory in warehouses and assembling shipments of inventory in response to orders.

FIG. 10 is a diagram of a system 1000 in accordance with an exemplary embodiment of the present invention. System 1000 includes order common helper system 610 and additional order common helper functionality for use in conjunction with an ERM system, as described below.

Order log helper 1002 receives order log query data, entry data, edit data, or other suitable data in an ERM system and returns the requested order log data or performs order log functions in response to the entry or edit data. For example, order log data can include items ordered, quantities ordered, prices, shipped from locations, shipped to locations, and other suitable order log data. Order log helper 1002 processes the order log data to generate suitable order reports at suitable locations, such as at internal provider locations, external provider locations, and internal order management and order tracking report systems.

Product price helper 1004 receives product price query data, edit data, entry data, or other suitable data in an ERM system and returns product price data in response to the query or performs the requested entry or update functions. Product price helper 1004 can interface with exchange rate helpers and other suitable functionality to convert product prices from foreign currencies into local currencies.

Tax jurisdiction helper 1006 receives tax jurisdiction query data, entry data, update data, or other suitable data in an ERM system and returns tax jurisdiction data in response to the query data or performs the requested data entry or update. In one exemplary embodiment, tax jurisdiction helper 1006 receives a request for tax jurisdiction data and tax rate data, and returns the tax jurisdiction and tax rate data that can be used to adjust the purchase price to compensate for tax that must be paid to the local jurisdiction where the sale is occurring. Tax jurisdiction helper 1006 can also update tax data, tax payment data, or the suitable tax data.

In operation, system 1000 provides common order functionality that may be required in conjunction with purchase order systems, sales order systems, inventory control systems, or other suitable systems in an ERM system. Such systems may be geographically diverse and require coordination between databases to prevent inadvertent corruption of the databases or other problems. System 1000 provides this coordination and other useful functions in conjunction with a suitable client-server communications system such as system 100, such that common order functionality can be provided on a multi-threaded basis to multiple users.

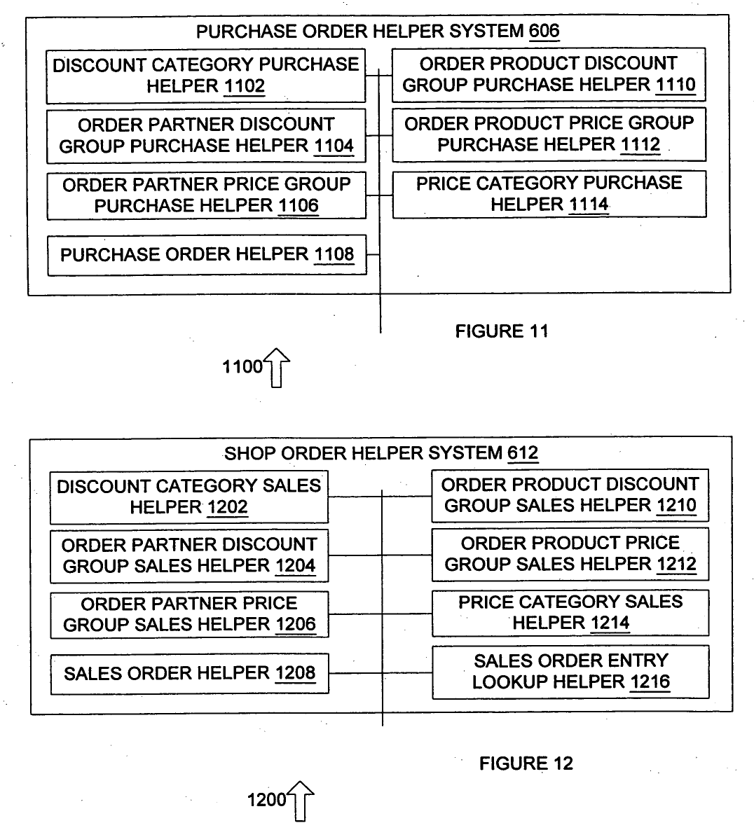

FIG. 11 is a diagram of a system 1100 for performing purchase order functionality in accordance with an exemplary embodiment of the present invention. System 1100 includes purchase order helper system 606 and additional helper functionality as described below, for use in an ERM system.

Discount category purchase helper 1102 receives discount category purchase query data, entry data, update data, or other suitable data in an ERM system and returns discount category purchase data in response to the query or performs the requested entry or update. In one exemplary embodiment, a user requests a discount category for a purchase based upon the purchaser's identity, the type of material being purchased, the location from which it is being purchased, or other suitable data. Discount category purchase helper 1102 receives the request and returns the discount category for the purchase based upon the query data.

Order partner discount group purchase helper 1104 receives discount group query data, entry data, update data, or other suitable data for a purchase by an order partner in an ERM system and returns the corresponding discount group data in response to the associated query or performs the requested data entry or update. In one exemplary embodiment, order partners such as internal organizations within an enterprise can receive discounts based upon predetermined categorizations, such that order partner discount group purchase helper 1104 can be used to determine corresponding discount groups for order partners.

Order partner price group purchase helper 1106 receives price group query data, entry data, update data, or other suitable data for a purchase by an order partner in an ERM system and returns the corresponding price group data in response to the associated query or performs the requested data entry or update. In one exemplary embodiment, order partners such as internal organizations within an enterprise can receive prices based upon predetermined categorizations, such that order partner price group purchase helper 1106 can be used to determine corresponding price groups for order partners.

Purchase order helper 1108 receives purchase order entry, edit or query data in an ERM system and performs purchase order entry or locates a related purchase order based on the query data. In one exemplary embodiment, purchase order helper 1108 receives user entered purchase order data and generates a purchase order in response to the purchase order data. For example, a user can enter purchase order data and can then activate purchase order helper 1108 to generate the purchase order. Purchase order helper 1108 can then return a request for entry of missing data fields or other suitable data, and it can generate a purchase order for use by the purchasing and selling organizations, inventory control data, general ledger data, and other suitable data.

Order product discount group purchase helper 1110 receives product discount group query data, entry data, update data, or other suitable data for an ERM system and returns product discount group data or performs the requested data entry or update. In one exemplary embodiment, a purchaser can use order product discount group purchase helper 1110 to see any discount groups that may apply for an ordered product, products that are offered under discount groups, or other suitable data.

Order product price group purchase helper 1112 receives product price group query data, entry data, update data, or other suitable data for an ERM system and returns product price group data or performs the requested data entry or update. In one exemplary embodiment, a purchaser can use order product price group purchase helper 1112 to see any price groups that may apply for an ordered product, products that are offered under price groups, or other suitable data.

Price category purchase helper 1114 receives price category query data, entry data, update data, or other suitable data in an ERM system and returns price category data in response to the price category query data or performs the requested data entry or update.

In operation, system 1100 provides purchase order functionality in response to user entered purchase order query data, entry data, edit data, or other suitable purchase order data in an ERM system. System 1100 provides multi-threaded purchase order functionality for an ERM system, including ERM systems that are distributed in geographically remote locations.

FIG. 12 is a diagram of a system 1200 for performing sales order functionality in an ERM system in accordance with an exemplary embodiment of the present invention. System 1200 includes sales order helper system 612 and additional helper functionality as described below.

Discount category sales helper 1202 receives discount category sales query data, entry data, update data, or other suitable data in an ERM system and returns discount category sales data in response to the query or performs the requested entry or update. In one exemplary embodiment, a user requests a discount category for a sale based upon the seller's identity, the type of material being sold, the location from which it is being sold, or other suitable data. Discount category sales helper 1202 receives the request and returns the discount category for the sale based upon the query data.

Order partner discount group sales helper 1204 receives discount group query data, entry data, update data, or other suitable data for a sale by an order partner in an ERM system and returns the corresponding discount group data in response to the associated query or performs the requested data entry or update. In one exemplary embodiment, order partners such as internal organizations within an enterprise can receive discounts based upon predetermined categorizations, such that order partner discount group purchase helper 1204 can be used to determine corresponding discount groups for order partners.

Order partner price group sales helper 1206 receives price group query data, entry data, update data, or other suitable data for a sale by an order partner in an ERM system and returns the corresponding price group data in response to the associated query or performs the requested data entry or update. In one exemplary embodiment, order partners such as internal organizations within an enterprise can receive prices based upon predetermined categorizations, such that order partner price group sales helper 1206 can be used to determine corresponding price groups for order partners.

Sales order helper 1208 receives sales order entry, edit or query data in an ERM system and performs sales order entry or locates a related sales order based on the query data. In one exemplary embodiment, sales order helper 1208 receives user entered sales order data and generates a sales order in response to the sales order data. For example, a user can enter sales order data and can then activate sales order helper 1208 to generate the sales order. Sales order helper 1208 can then return a request for entry of missing data fields or other suitable data, and can generate a sales order for use by the purchasing and selling organizations, inventory control, general ledger data, and other suitable data.

Order product discount group sales helper 1210 receives product discount group query data, entry data, update data, or other suitable data for an ERM system and returns product discount group data or performs the requested data entry or update. In one exemplary embodiment, a seller can use order product discount group sales helper 1210 to see discount groups that may apply for an ordered product, products that are offered under discount groups, or other suitable data.

Order product price group sales helper 1212 receives product price group query data, entry data, update data, or other suitable data for an ERM system and returns product price group data or performs the requested data entry or update. In one exemplary embodiment, a seller can use order product price group sales helper 1212 to see any price groups that may apply for an ordered product, products that are offered under price groups, or other suitable data.

Price category sales helper 1214 receives price category query data, entry data, update data, or other suitable data in an ERM system and returns price category data in response to the price category query data or performs the requested data entry or update.

Sales order entry lookup helper 1216 receives sales order entry lookup query data or other suitable data in an ERM system and returns sales order data in response to the query or other suitable data. Sales order entry lookup helper 1216 can be used to locate previous sales orders for a customer to facilitate the entry of new orders, to perform sales order audits, or for other suitable sales order lookup functions in an ERM system.

In operation, system 1200 provides sales order functionality in response to user entered sales order query data, entry data, edit data, or other suitable sales order data in an ERM system. System 1200 provides multi-threaded sales order functionality for an ERM system, including ERM systems that are distributed in geographically remote locations.

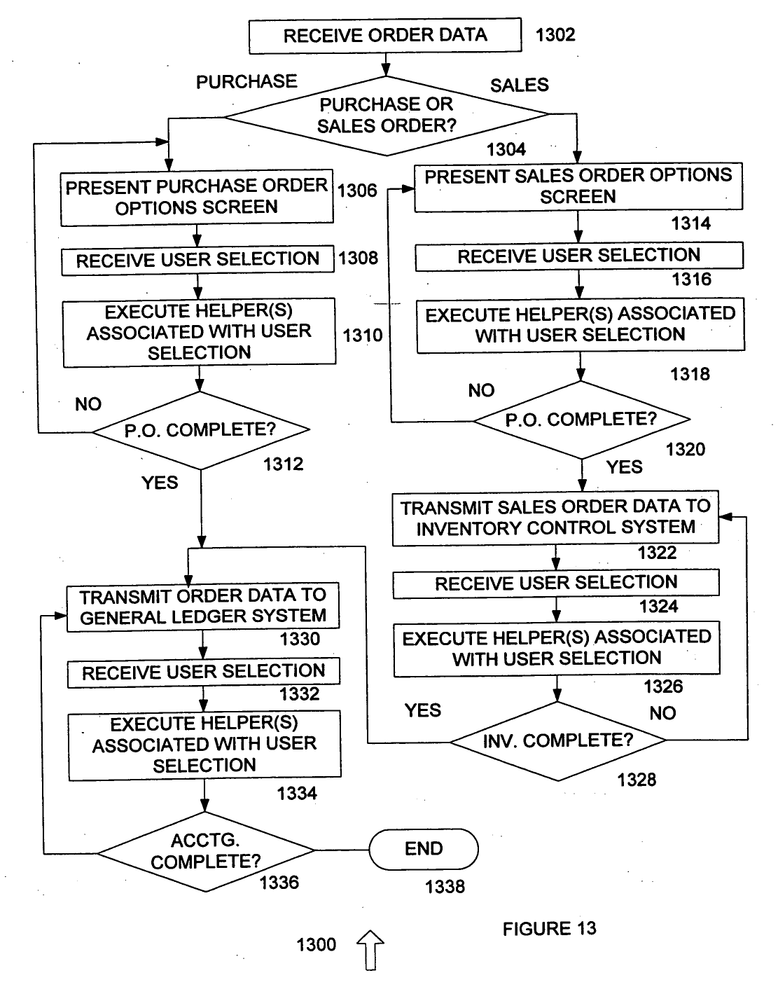

FIG. 13 is a flowchart of a method 1300 for performing ERM using one or more sales order helpers, purchase order helpers, inventory control helpers, general ledger helpers, global helpers, or order common helpers in accordance with an exemplary embodiment of the present invention. Method 1300 allows multiple threads of helper functionality to be initialized and executed for performing functions in an ERM system, such that large enterprises having a plurality of users can perform ERM in response to the needs of the enterprise.

Method 1300 begins at 1302 where order data is received, such as from an order entry screen in an ERM system. The method then proceeds to 1304 where it is determined whether a purchase order or a sales order has been received. For example, a customer can enter a purchase order for processing an order that has been placed with a selling entity. Likewise, a selling entity can enter a sales order in response to a purchase order or in response to verbal request or other information. If it is determined at 1304 that a purchase order has been received, the method proceeds to 1306 where a purchase order option screen is presented to the user that is generating the purchase order. The purchase order option screen includes one or more options for use in an ERM system, such as options related to identification of internal price or discount codes, identification of locations or items from keywords, identification of units of measure or sizes, or other suitable options. The method then proceeds to 1308.

At 1308, a user selection from the purchase order option screen is received. The method then proceeds to 1310 where helpers are initialized and executed that are associated with the purchase order option that has been selected by the user, such as helpers that perform functions, obtain data, generate reports, or other suitable helpers. The helpers can include global or order common helpers that can also be used for other suitable functions. The method then proceeds to 1312 where it is determined whether the purchase order is completed. If it is determined that the purchase order is completed the method proceeds to 1330, otherwise the method returns to 1306.

If it is determined at 1304 that a sales order has been entered then the method proceeds to 1314 where a sales order option screen is presented to the user. The sales order option screen includes one or more options for use in an ERM system, such as options related to identification of internal price or discount codes, identification of locations or items from keywords, identification of units of measure or sizes, or other suitable options. The method then proceeds to 1316 where a user selection is entered. At 1318, one or more helpers associated with the user selection are initialized and executed, such as helpers that perform functions, obtain data, generate reports, or other suitable helpers. The helpers can include global or order common helpers that can also be used for other suitable functions. The method then proceeds to 1320 where it is determined whether the sales order is completed. If the sales order is not completed, then the method returns to 1314. Otherwise, the method proceeds to 1322.

At 1322, sales order data is transmitted to an inventory control system in an ERM system. The method then proceeds to 1324 where a user selection at the inventory control system is received. In one exemplary embodiment, the user selection can include a selection from an option screen that includes options for the generation of inventory retrieval reports, inventory tracking reports, and other suitable inventory control options in an ERM system. The method then proceeds to 1326 where one or more helpers associated with the user selection are initialized and executed, such as helpers that perform functions, obtain data, generate reports, or other suitable helpers. The helpers can include global or order common helpers that can also be used for other suitable functions. The method then proceeds to 1328 where it is determined whether any more inventory control data processing functionality is required, such as to generate shipping reports, order fulfillment reports, or other suitable inventory control data. If additional functionality is required the method returns to 1322. Otherwise the method proceeds to 1330.

At 1330, purchase order data, sales order data, or inventory control data is transmitted to a general ledger system. The method then proceeds to 1332 where user selections are received at the general ledger system in response to the order data and shipment data and other associated data with the order. For example, a general ledger options screen can be generated that presents general ledger functions for use in an ERM system, such as options to generate billing reports, accounts receivable reports, options to perform journal update or entry, or other suitable functions. The method then proceeds to 1334 where one or more helpers associated with the user selections are initialized and executed. The helpers can include global or order common helpers that can also be used for other suitable functions. The method then proceeds to 1336 where it is determined whether any more general ledger data is received. If additional general ledger data requires processing the method returns to 1330. Otherwise, the method proceeds to 1338 and terminates.

In operation, method 1300 allows ERM to be performed using one or more helpers such that purchase order, sales order, inventory control, and general ledger functionality can be provided in a multi-threaded environment that performs the provision of ERM services to a plurality of users, such as users in a large enterprise. System 1300 thus allows ERM to be performed with distributed databases, warehouses, users, purchasers, shipping entities, purchasing entities, and general ledger functionality in a distributed environment.

Although exemplary embodiments of a system and method for performing ERM in a multi-threaded environment have been described in detail herein, those skilled in the art will also recognize that various substitutions and modifications can be made to the systems and methods without departing from the scope and spirit of the appended claims.

1-21. (canceled)

22. A system for communicating between a client and a server comprising:
a server thread system receiving a request packet and initiating a server thread process for the client;
a process thread system receiving the request packet from the server thread system and initiating a process thread process with a helper system in response to the request packet; and
wherein the process thread system does not initiate the process thread process if the process thread process has previously been initiated in response to a previous request packet.

23. The system of claim 22 wherein the helper system comprises a purchase order helper system receiving purchase order entry data and generating purchase order data.

24. The system of claim 22 wherein the helper system comprises a sales order helper system receiving sales order entry data and generating sales order data.

25. The system of claim 22 wherein the helper system comprises an inventory control helper system generating inventory control data.

26. The system of claim 22 wherein the helper system comprises a general ledger helper system generating general ledger data.

27. The system of claim 22 wherein the helper system comprises a global helper system providing predetermined common helper functions to each of a sales order helper system, a purchase order helper system, an inventory control helper system, and a general ledger helper system.

28. The system of claim 22 wherein the helper system comprises an order common helper system providing predetermined common helper functions to each of a sales order helper system and a purchase order helper system.

29. The system of claim 26 wherein the general ledger helper system further comprises one or more of the group including an account helper, an analysis helper, a bank helper, a chart of accounts helper, an exchange rate helper, an external bank helper, a financial reports helper, a fiscal calendar helper, a balance inquiry helper, a mapping helper, a posting helper, a table helper, an internal bank helper, a journal entry helper, and a revalue currency helper.

30. The system of claim 25 wherein the inventory control helper system further includes one or more of the group comprising a discount category internal helper, an inventory adjustment helper, an inventory helper, a location controlled warehouse helper, an order partner discount group internal helper, an order partner price group internal helper, an order product discount group internal helper, an order product price group internal helper, a pick confirmation helper, a price category internal helper, a product helper, a stock location helper, a stock location move helper, a stock location movement helper, a stock receipt helper, a stock zone helper, a transaction audit helper, a unit category helper, a warehouse helper, a warehouse work unit helper.

31. The system of claim 23 wherein the purchase order helper system further includes one or more of the group comprising a discount category purchase helper, an order partner discount group purchase helper, an order partner price group purchase helper, an order product discount group purchase helper, an order product price group purchase helper, a purchase order helper, and a price category purchase helper.

32. The system of claim 24 wherein the sales order helper system further comprises one or more of the group comprising a discount category sales helper, an order partner discount group sales helper, an order partner price group sales helper, an order product discount group sales helper, an order product price group sales helper, a sales order helper, a price category sales helper, and a sales order entry lookup helper.

33. The system of claim 27 wherein the global helper system further comprises one or more of the group including an ABC class codes helper, a buyer codes helper, a company maintenance helper, a country code helper, a currency helper, a customer helper, a customer key word helper, a customer ship to helper, a freight terms helper, a language help helper, a language resource helper, a locale code helper, a main menu helper, a message helper, an object oriented SQL helper, a payment terms helper, a product group code helper, a product key word helper, a ship via helper, a unit of measure helper, a user maintenance helper, a vendor helper, and a vendor key word helper.

34. The system of claim 28 wherein the order common helper system further comprises one or more of the group including an order log helper, a product price helper, and tax jurisdiction helper.

35. A method for communicating between a client and a server comprising:
initiating a server thread process when the client logs onto the server to manage the client connection to the server;
initiating a process thread process in response to a request packet, to manage the generation of a response packet in response to the request packet; and
wherein the process thread process interfaces with one or more helper systems and ignores the request packet if the process thread process is already active.

36. The method of claim 35 wherein the one or more helpers include helpers from the group comprising a general ledger helper system, a global helper system, an inventory control helper system, an order common helper system, a purchase order helper system and a sales order helper system.

37. The method of claim 36 wherein the sales order helper system further comprises one or more helper from the group comprising a discount category sales helper, an order partner discount group sales helper, an order partner price group sales helper, an order product discount group sales helper, an order product price group sales helper, a sales order helper, a price category sales helper, and a sales order entry lookup helper.

38. The method of claim 36 wherein the purchase order helper system further comprises one or more helper from the group comprising a discount category purchase helper, an order partner discount group purchase helper, an order partner price group purchase helper, an order product discount group purchase helper, an order product price group purchase helper, a purchase order helper, and a price category purchase helper.

39. The method of claim 36 wherein the inventory control helper system further comprises one or more helpers from the group comprising a discount category internal helper, an inventory adjustment helper, an inventory helper, a location controlled warehouse helper, an order partner discount group internal helper, an order partner price group internal helper, an order product discount group internal helper, an order product price group internal helper, a pick confirmation helper, a price category internal helper, a product helper, a stock location helper, a stock location move helper, a stock location movement helper, a stock receipt helper, a stock zone helper, a transaction audit helper, a unit category helper, a warehouse helper, and warehouse work unit helper.

40. The method of claim 36 wherein the general ledger helper system further comprises one or more helpers from the group comprising an account helper, an analysis helper, a bank helper, a chart of accounts helper, an exchange rate helper, an external bank helper, a financial reports helper, a fiscal calendar helper, a balance inquiry helper, a mapping helper, a posting helper, a table helper, an internal bank helper, a journal entry helper, and a revalue currency helper.
